(19) United States
(12) Patent Application Publication
(10) Pub. No.: US 2015/0358976 A1
(43) Pub. Date: Dec. 10, 2015

(54) Protecting UL Control Channels in Dynamic/Flexible TDD

(71) Applicant: TELEFONAKTIEBOLAGET L M ERICSSON (PUBL), Stockholm (SE)

(72) Inventors: Imadur Rahman, Sollentuna (SE); Erik Eriksson, Linköping (SE); Eliane Semaan, Vällingby (SE)

(21) Appl. No.: 14/761,322

(22) PCT Filed: Jan. 28, 2014
(86) PCT No.: PCT/EP2014/000226

§ 371 Date: Jul. 16, 2015

Related U.S. Application Data
(60) Provisional application No. 61/757,455, filed on Jan. 28, 2013.

(51) Int. Cl. H04W 72/08; H04W 74/00; H04L 5/14; H04L 5/00

(52) U.S. Cl. CPC H04W 72/082; H04L 5/0048; H04W 74/004; H04L 5/14

(57) ABSTRACT

The invention relates to a method for allocation of radio resources in a radio base station (BS1) of a communication network, comprising adapting resource allocation for radio transmission in said radio base station (BS1) based on information on resource allocation in a neighbouring radio base station (BS2), such that interference of signals transmitted from said radio base station (BS1) with signal transmitted from or received by the neighbouring radio base station (BS2) is reduced, a corresponding method of operating a communication system, and a corresponding radio base station (BS1) and communication system.

### TECHNICAL FIELD

The present invention relates to methods and devices for controlling scheduling of resources in a radio network wherein radio transceivers, particularly radio base stations, may cause interference to each other. Particularly, the invention relates to a method for allocation of radio resources in a radio base station (BS1) of a communication network, a method for operating a communication system, the system comprising a first radio base station and a second radio base station, a corresponding radio base station and corresponding communication system.

### BACKGROUND

In current Time Division Duplex (TDD) systems, different uplink/downlink (UL/DL) configurations are specified. For example, seven different UL/DL configurations are defined for LTE-TDD systems in 3GPP TS 36.211 V11.1.0 (2012-12), see specifically Table 4.2-2. One of the prime benefits of TDD systems is that the system available bandwidth can be adjusted to the traffic patterns at the base station. This is in contrary to FDD systems, where the bandwidth in the UL and DL are fixed and cannot be changed based on traffic patterns (or the bandwidth requirement at any node). Exploiting this benefit at cell-by-cell basis also means that cross links in neighbouring cells (i.e. UL and DL links) may interfere with each other, which is a new phenomenon compared to traditional FDD systems.

In recent times, considerations have been made on how best to exploit different TDD configurations in different nodes of the network to dynamically adopt the TDD configurations based on the instantaneous traffic seen at any certain node, see e.g. the paper of Erik Eriksson et al., “Dynamic Uplink-Downlink Configurations and Interference Managements in TD-LTE”, IEEE Communications Magazine Vol. 50 No. 11, November 2012.

However, in TDD systems, there is a possibility that neighbouring base stations may use different UL/DL configurations, resulting in DL-to-UL interference, resp. transmitting base station (BS) to receiving base station (BS) interference. This can cause interference in receiving UL control and data channels, which will in turn affect the DL transmissions of the interfered cell.

An example BS-to-BS interference scenario is shown in FIG. 1. This figure depicts two neighbouring cells of a mobile communication system, each comprising a base station (BS) BS1 resp. BS2 which communicates with a mobile terminal or user equipment (UE) UE 1 resp. UE 2 in the respective cell. According to the example, at a certain point in time, BS 1 of the first cell is transmitting in the downlink, while BS 2 of the second cell is receiving in the Uplink. The DL signal of BS 1 in the first cell can cause interference to the UL signal in of BS 2 in the second cell, as usually downlink signals have a higher signal strength than uplink signals. In such a case, the interference levels can be very high, e.g. if the interfering base station BS 1 in the first cell is a macro BS it will typically transmit with 46 dBm transmit power. Further, under some circumstances, there may be a LOS (Line of Sight) link between the base stations in the neighbouring cells, e.g. if the victim base station BS 2 in the second cell is another macro BS. All in all, this potentially causes a high level of interference, particularly if the interfering node (BS) transmits using high power and reception conditions at the interfered node (BS) are good.

### SUMMARY

It is thus a goal of the present invention to provide methods and devices to mitigate or avoid the mentioned effects, particularly to protect the UL control channels in the interfered BS when both the interfered BS and interfering BS are operating in co-channel.

This goal is achieved generally by taking into account, by a station in a communication network, resource allocation in a neighbouring station, and adapting resource allocation such that interference of the transmitted signals with signal transmitted or received by the neighbouring base station is reduced.

Particularly, there is provided a method for allocation of radio resources in a radio base station of a communication network, comprising adapting resource allocation for radio transmission in said radio base station based on information on resource allocation in a neighbouring radio base station. Therein, the adapting is done such that interference of signals transmitted from said radio base station with signal transmitted from or received by the neighbouring radio base station is reduced.

Further, there is provided a method for operating a communication system, the system comprising a first radio base station and a second radio base station, comprising adapting resource allocation for radio transmission in the first radio base station based on information on resource allocation in the second radio base station. Therein, the adapting is done such that interference of signals transmitted from the first radio base station with signal transmitted from or received by the second radio base station is reduced.

Further, there is provided a radio base station of a communication network, said radio base station being adapted to obtain information on uplink resource allocation in a neighbouring radio base station and to adapt allocation of downlink resources based on said information, and a communication system, comprising a first radio base station and a second radio base station, the communication network being capable of adapting resource allocation for radio transmission in the first radio base station based on information on resource allocation in the second radio base station.

Further, there is provided a computer program comprising code which, when executed by one or more processors, causes the processor(s) to perform the above-described method, and a data carrier comprising said computer program.

### BRIEF DESCRIPTION OF THE DRAWINGS

Further characteristics and advantages of the invention will become better apparent from the detailed description of particular but not exclusive embodiments, illustrated by way of non-limiting examples in the accompanying drawings, wherein:

FIG. 1 shows an example of BS-to-BS interference caused due to UL/DL asymmetry between neighbouring cells;

FIG. 2 shows an example for PUCCH transmission in UL;

FIGS. 3 and 4 show exemplary resource allocation configurations in TDD;

FIG. 5 shows an example for DL-to-UL interference;

FIG. 6 shows an exemplary communication system;

FIGS. 7 and 8 depict examples of measures for interference reduction;

FIG. 9 depicts an exemplary base station.

### DETAILED DESCRIPTION

As mentioned above, there is provided a method for allocation of radio resources in a first radio base station of a communication network, comprising adapting resource allocation for radio transmission in said first radio base station based on information on resource allocation in a second, or neighbouring, radio base station. Therein, the adapting is done such that interference of signals transmitted from said first radio base station with signal transmitted from or received by the second radio base station is reduced.

Further there is provided a method for operating a communication system, the system comprising a first radio base station and a second radio base station, comprising adapting resource allocation for radio transmission in the first radio base station based on information on resource allocation in the second radio base station. This adaptation is applied such that interference of signals transmitted from the first radio base station with signal transmitted from or received by the second radio base station is reduced.

Said information on resource allocation in said neighbouring station may be obtained or transmitted via a communication link between the radio base station and the neighbouring radio base station. The first radio base station may request information on resource allocation in said neighbouring radio base station, or the second radio base station may transmit this information on its own initiative.

Particularly, information on uplink resource allocation in a neighbouring station may be obtained and allocation of downlink resources may be adapted based on said information.

The said information may for example comprise information on resource elements in which the neighbouring radio base station has scheduled uplink resources; accordingly, said adapting resource allocation for radio transmission may comprise not scheduling downlink resources in resource elements corresponding to the resource elements in which the neighbouring radio base station has scheduled uplink resources. Therein, the resource elements may comprise resource elements carrying an uplink control channel, particularly a physical uplink control channel, PUCCH, of a mobile communication system, for example an LTE communication system.

Apparently, resource elements in which information or channels are carried that is/are subject to interference or particularly vulnerable to interference, are of special interest and may thus be considered.

In the context of this application, a resource element is a basic element of a physical resource used for radio transmission. It may be expressed in terms of time, frequency resp. bandwidth, carrier code, or any combination thereof.

Additionally or in alternative, the method may comprise obtaining information on a level of interference experienced by the neighbouring radio base station and adapting resource allocation for radio transmission in said radio base station based on this information. Therein, the level of interference experienced by the second radio base station may be determined, for example by measurement by the second base station, and information on the level of interference may be transmitted to the first radio base station. The first radio base station may then adapt resource allocation for radio transmission based on this information

The adapting of the resource allocation for radio transmission may be done in several ways. For example, a radio bandwidth and/or transmission power for downlink transmission may be reduced. Further, frequency allocation may be shifted, for example between neighbouring cells and/or between uplink and downlink.

The first radio base station may send a notification to a mobile station or to all mobile stations served by the first radio base station about the adapting of resource allocation. For example, the mobile station(s) may be notified that certain resource blocks will not be used for downlink transmissions by the radio base station. This notification may e.g. be broadcasted to all mobile stations within a cell served by the radio base station.

Generally, the communication network resp. system may be a time division duplex (TDD) wireless communication system and the first and/or second radio base stations may be a radio base station of a time division duplex (TDD) wireless communication system.

Said first and/or second radio base stations may for example be base stations or access points of a wireless communication system. In this case, the term “downlink” relates to transmission of signals from a radio base station or access point to a mobile station, for example a user equipment (UE), and the term “uplink” relates to transmission from a mobile station, e.g. a UE, to a base station or access point.

Particularly, said first station may comprise a transmitter capable of transmission of downlink signals, an interface capable of obtaining information on uplink resource allocation in a neighbouring (second) station, and one or more processors capable of interpreting said information and adapting resource allocation.

Finally there is provided a computer program, comprising program code which, when executed by one or more processors, performs the steps of the above-described method. Processor(s) to execute this program may be general purpose or dedicated signal processors and may be connected to or comprise a memory for storing the program. Further, a data carrier comprising the computer program may be provided. Said data carrier may be any volatile or non-volatile carrier, including magnetic, optical, magneto-optic or semiconductor memory devices like magnetic tapes, harddisc drive, CD-ROM, DVD, flash memory, RAM, ROM and the like, and also including signals, particularly electric or electromagnetic signals.

In the following, embodiments of the invention will be described in more detail with respect to the figures.

Note that although terminology from 3GPP LTE will be used in the following to exemplify the invention, this should not be seen as limiting the scope of the invention to only the aforementioned system. Other wireless systems, including WCDMA, WiMax, and UMB (or any other system that runs on TDD), may also benefit from exploiting the ideas covered within this disclosure.

Also note that terminology such as base station should be considered non-limiting and does in particular not imply a certain hierarchical relation between the two; in general “base station” could be considered as device or node 1 and another base station could be considered as device or node 2, and these two devices resp. nodes communicate/interfere with each other over some radio channel.

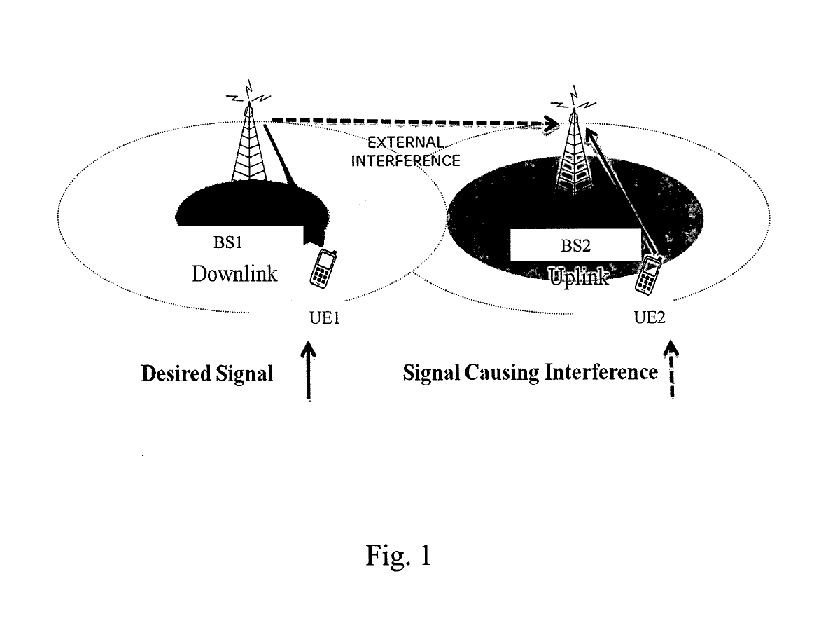

FIG. 1 shows a communication system comprising a first radio base station BS1 serving a mobile station UE1 and a second radio base station BS2 serving a mobile station UE2. In this example, first radio base station BS1 is at the moment operating in downlink operation and second radio base station BS2 is operating in uplink operation. The respective desired signals between each radio base station BS1, BS2 and the served mobile stations UE1, UE2 are shown as solid arrows, while a signal emitted by the first radio base station BS1 which can cause interference to the communication between second radio base station BS2 and the served mobile station UE2 is shown as a dashed arrow.

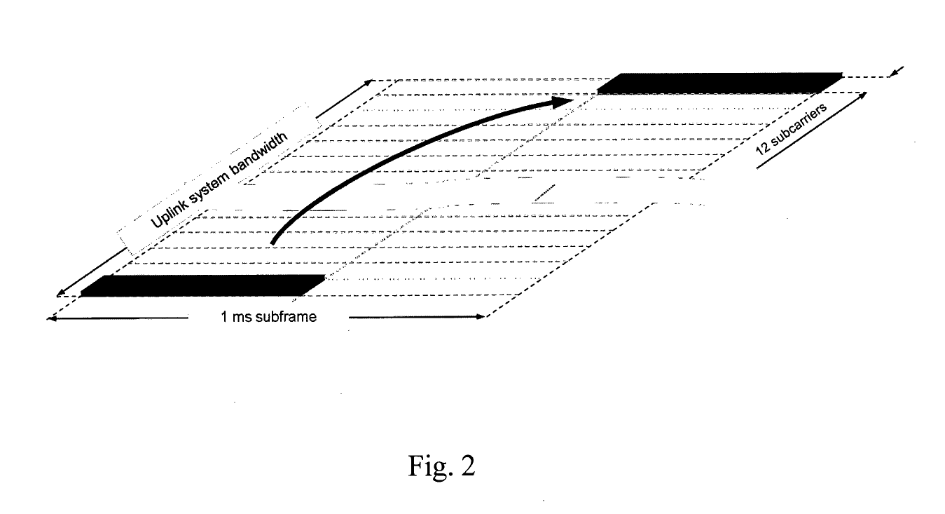

In an exemplary LTE system, the Physical Uplink Control Channel (PUCCH) is transmitted in the edge of the frequency carrier as shown in FIG. 2. When PUSCH (Physical Uplink Shared Channel) is not scheduled, then an UE (user equipment) is scheduled to transmit control information (e.g. HARQ feedback, channel status report, scheduling requests, etc) in PUCCH. Specific frequency resources (e.g. multiples of 180 kHz in LTE, or resource blocks) at the edges of the uplink spectrum are reserved for PUCCH and frequency-hopping is employed at the slot border to obtain diversity. Together, the two resource blocks shown in FIG. 2 are referred to as a PUCCH region. In LTE, The number of PUCCH regions typically depends on the system bandwidth as shown in the following Table:

| Bandwidth (MHz) | Number of PUCCH regions |
|---|---|
| 1.4 | 1 |
| 3 | 2 |
| 5 | 4 |
| 10 | 8 |
| 20 | 16 |

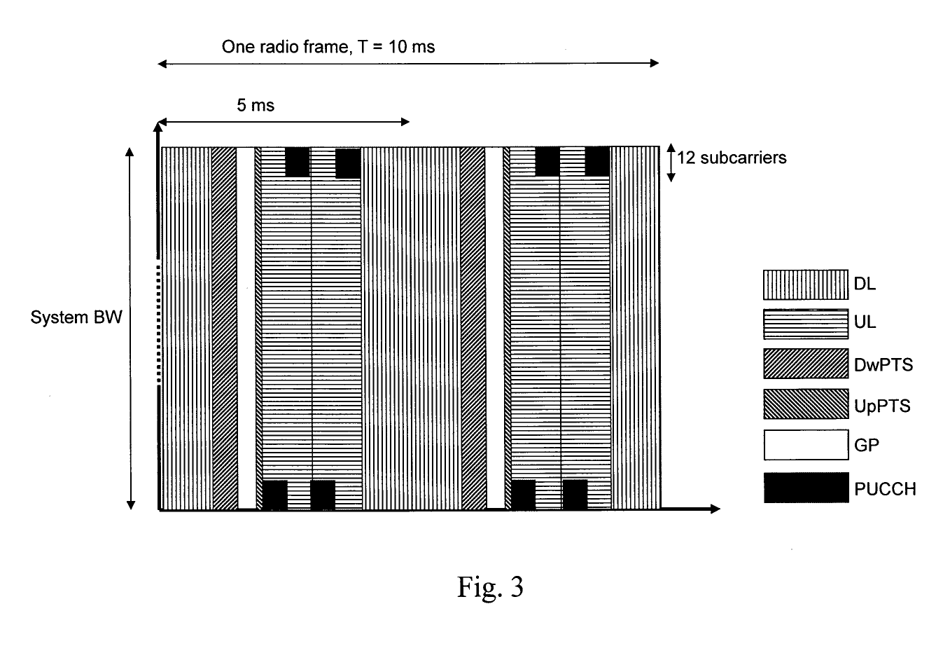

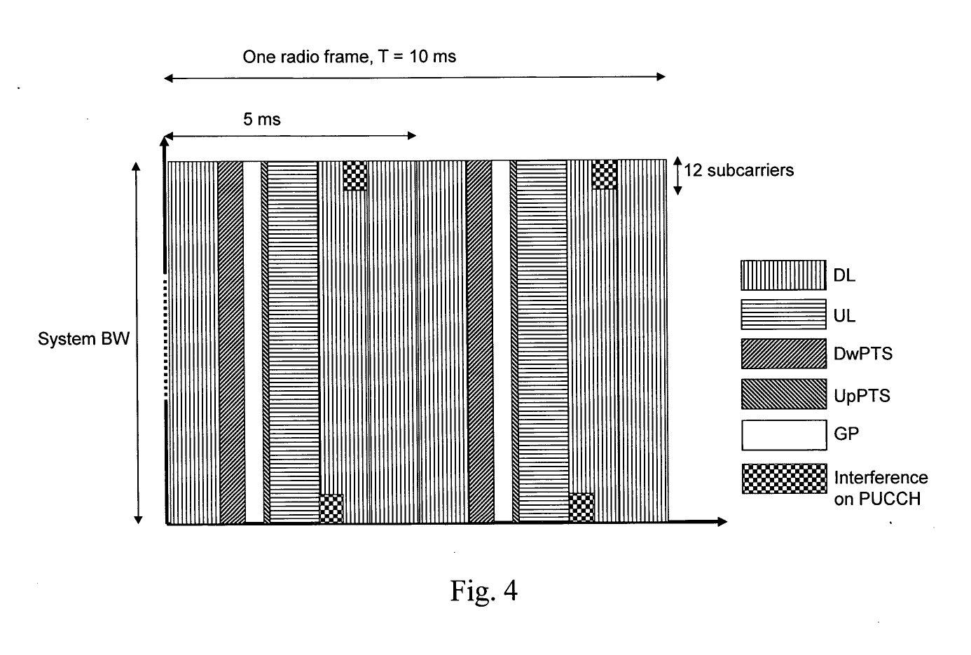

Usually, the Uplink Control Channel (e.g. PUCCH) is not protected from potential downlink interference coming from other base stations as depicted in FIG. 1. For instance, if the DL/UL configuration at a victim base station corresponds to TDD configuration DL:UL 3:2, the resource blocks allocated for PUCCH transmission can be seen in FIG. 3. Hence, if these resource blocks are used for downlink transmissions in a neighbouring cell, e.g. in case TDD configuration 2 (DL:UL 4:1) is used in a neighbouring cell as shown in FIG. 4, the PUCCH resource blocks will be interfered by the downlink transmission of the neighbouring base station. As a result, both UL and DL transmissions in the victim cell will be badly affected.

FIG. 3 shows an exemplary resource block allocation in an LTE radio base station in TDD configuration. Therein, a radio frame of 10 ms duration, having a certain system bandwidth, is shown, comprising inter alia blocks used for downlink (vertically hatched), for uplink (horizontally hatched) and for PUCCH (solid). FIG. 4 shows another exemplary resource block allocation in an LTE radio base station in TDD configuration. Again, blocks used for downlink (vertically hatched), for uplink (horizontally hatched) and for PUCCH (dotted) are comprised; however, the blocks used for PUCCH experience interference due to a signal from a neighboured base station.

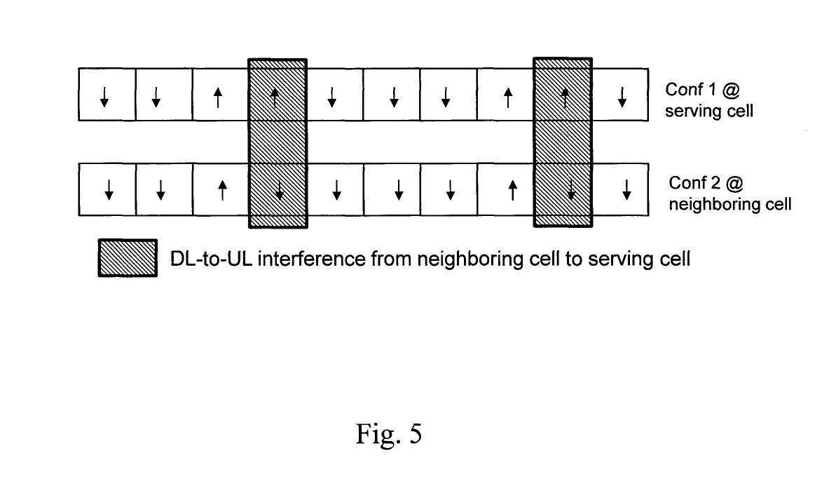

Another example of a resource allocation configuration is shown in FIG. 5. The top row shows resource allocation for a first radio base station, for example radio base station BS1 of FIG. 1, and the lower row shows resource allocation for a second radio base station, for example radio base station BS2 of FIG. 1. Up arrows indicate uplink scheduling in a certain time frame and down arrows indicate downlink scheduling. It can be seen that in time frames when the first radio base station is scheduled for downlink and the second radio base station is scheduled for uplink, interference may be caused from the first radio base station to the second radio base station, as indicated by the diagonally hatched rectangles.

Note that the problem description presented in this section is also relevant in case other TDD configurations are used, as well as in case a different number of resource blocks is allocated for PUCCH transmission.

This problem can be addressed by taking into account resource allocation in a neighbouring station, and adapting resource allocation such that interference of the transmitted signals with signal transmitted or received by the neighbouring base station is reduced, as described above. This can be accomplished by a station of a time division duplex (TDD) wireless communication system by obtaining information on uplink resource allocation in a neighbouring station and adapting allocation of downlink resources to said information.

For example, a base station (BS) obtains information about the TDD configurations, as e.g. shown in FIG. 3, used in the neighbouring BSs. This information can be obtained via X2 interface, or via any other means of network coordination. Using this information, a potentially interfered BS may request the potentially interfering BS to avoid DL transmission in PUCCH region when an UE is scheduled at PUCCH in the potentially interfered BS.

In one embodiment, the potentially interfering BS can utilize its knowledge of TDD configurations in neighbouring potentially interfered BSs and decide not to schedule any DL transmission in the band edges, without even being requested by the potentially interfered BS in subframes that may contain PUCCH in the neighbouring node.

In another embodiment, the frequency regions where the DL transmitter, resp. the potentially interfering BS, avoids DL allocation can be in any other parts of the band, and it can be of any size, e.g. more than 1 PRB (or 180 KHz).

In one embodiment, a network node or BS that detects or predicts interference from a neighbour node may send a message to the (potentially) interfering node indicating the resources used for PUCCH in the given cell or other time frequency resources needed protecting, e.g. in terms of resource blocks, subframes and/or power levels. Such signalling may be transmitted over a direct interface between the nodes, such as X2, or through a third network management node. The signalling may also originate directly for a management node without interference measurements/predictions where a number of resource blocks are reserved from downlink scheduling in all subframes not belonging to a preconfigured subset of subframes.

The information to be transmitted could include for example uplink resources, e.g. PUCCH resources used in the base station, potential future uplink resources, e.g. PUCCH reception in future UL subframes in the base station, and/or interference level experienced or measured at the victim UL receiver, for example if base station to base station interference measurement capabilities are available.

In some embodiments, a network node potentially causing interference to a different cell PUCCH may indicate to a served UE the reserved resource blocks. In this case the served UE may assume that no data will be mapped to these resource blocks in an indicated subset of the downlink subframes and in some embodiments it may assume that reference signals, such as CRS or CSI-RS will not be present in the indicated resource blocks in the given subframes. The information may include broadcast information to all served UEs in the interfering cell. The information may for example be one bit to indicate null transmission in certain subframes, or it could be pattern information for the said null transmissions.

In some embodiments the intended protection of uplink control channels may be realized by applying a smaller system bandwidth configuration on downlink compared to uplink, at least for the subframes where harmful BS-to-BS interference may be generated. In the current LTE framework, six distinct transmission bandwidth values are defined, thus reducing the DL bandwidth means to come down to another, lower transmission bandwidth.

An alternative to reducing the bandwidth would be to instead shift the frequency between cells and/or between uplink and downlink by the size of the PUCCH region or similar, in order to protect parts of the PUCCH transmission. With such a solution parts of the frequency diversity gain on PUCCH would be lost but it could be compensated for by applying a different power control.

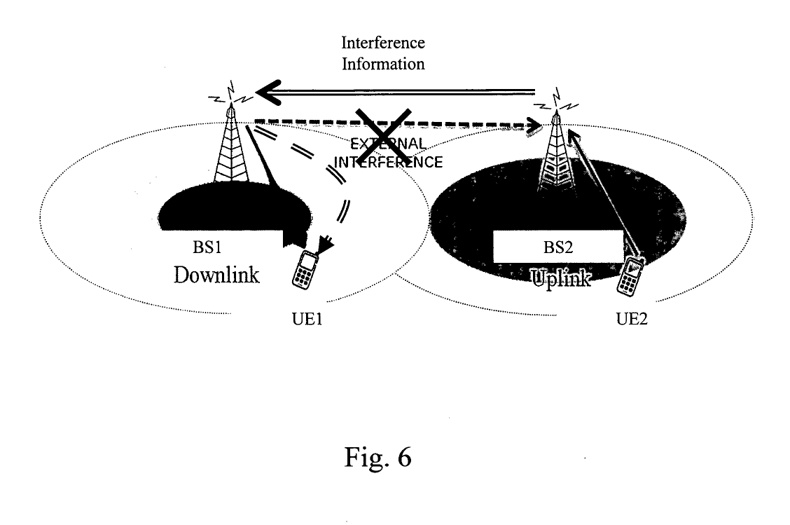

FIG. 6 shows an exemplary communication system similar to the system of FIG. 1 and using the same reference signs. Again, second radio base station BS2 may experience interference by signals transmitted by first radio base station BS1. Thus, second radio base station transmits information to first radio base station BS1. This information may e.g. comprise information on resource allocation in second radio base station BS2 and/or on interference measured by second radio base station BS2. Based thereon, first radio base station BS1 may then adapt its own resource allocation in order to avoid causing interference, or at least reduce interference.

Optionally, the first radio base station BS1 may inform mobile station UE1 about the adapted resource allocation, as indicated by the dashed double arrow.

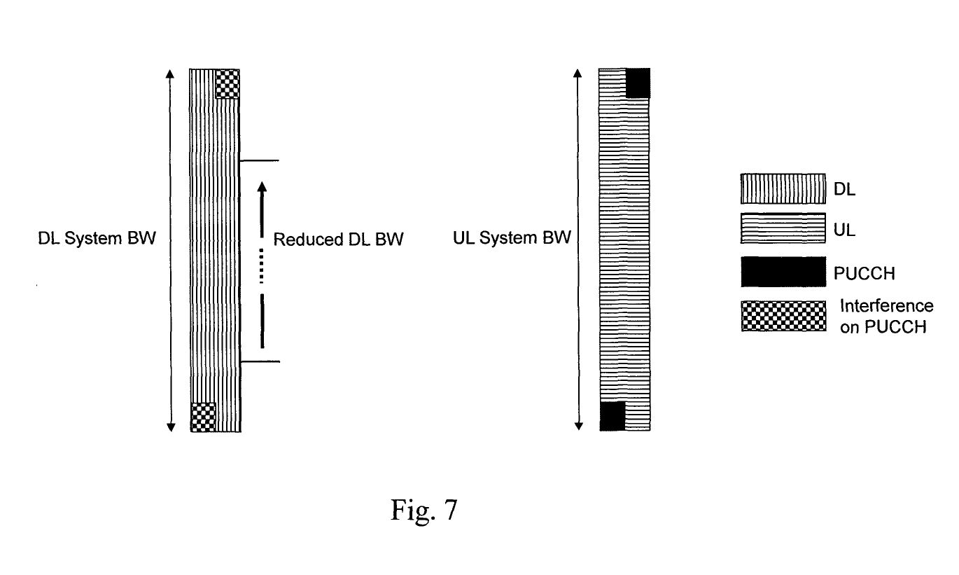

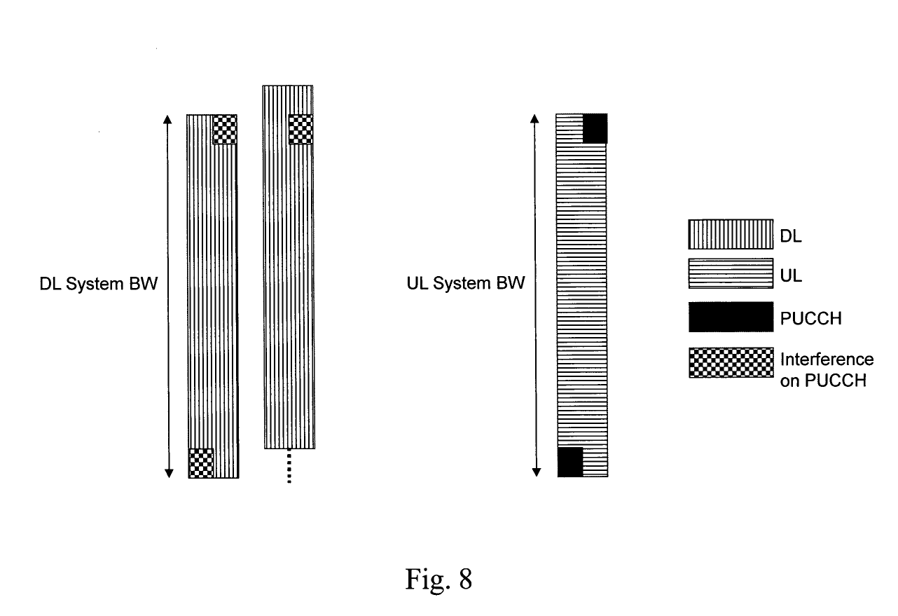

Exemplary measures that can be taken in order to avoid or reduce interference are shown in FIGS. 7 and 8.

FIG. 7 shows, on the right side, an example for UL bandwidth usage, showing the usable system bandwidth and the parts thereof that are used for UL transmission (horizontally hatched) and PUCCH (solid). On the left side, an example for DL bandwidth usage is shown, again showing the usable system bandwidth and the parts thereof that are used for DL transmission (vertically hatched) and that could cause interference with PUCCH (dotted). If a reduced DL bandwidth is used, as shown with the dotted double-arrow, the parts that could cause interference with PUCCH are not used anymore.

An alternative measure is shown in FIG. 8. The initial situation is the same as described with respect to FIG. 7, i.e. the DL bandwidth encompasses parts that could interfere with a PUCCH (dotted). In this example, the bandwidth is kept, but the used frequency band is shifted as indicated in the block second from the left. Thereby, at least one frequency part used for PUCCH is not encompassed from the DL bandwidth anymore, leading to reduced interference. This may for example be sufficient if not all resources that are vulnerable to interference are actually used by the interfered base station, e.g. if only one of the two resource blocks used for PUCCH is actually scheduled for PUCCH transmission.

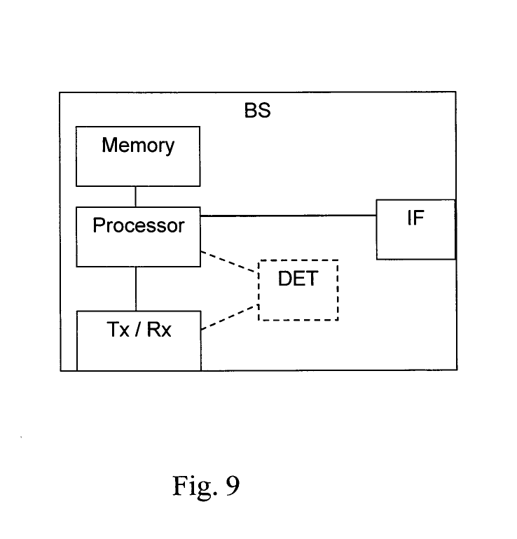

An exemplary base station BS, which could be used as any of the base stations shown in FIG. 6, and particularly as the first base station BS1, is depicted in FIG. 9. Said base station comprises a transmit/receive unit Tx/Rx, which is capable of communicating with a mobile station like a UE of FIG. 1 according to a TDD configuration like the ones depicted in FIG. 3, 4 or 5.

Base station BS further comprises a processor, which may be any type of general-purpose or specialized processor, and which may also be comprised of more than one processor; functionalities as described above and further below may be implemented by said processor, e.g. in form or a computer program being executed by said processor. Said computer program may be stored on a memory of the base station BS.

Base station BS further comprises an interface IF for communicating with a neighbouring base station or a network management node, which interface is capable of transmitting and/or receiving information on the resource allocation resp. TDD configuration.

In the case of transmitting said information, base station BS may inform a neighbouring base station or a network management node (and via this node indirectly a neighbouring base station) on resource allocations that may be subject to interference, e.g. UL allocations like PUCCH, and thus indicate that the neighbouring base station should take measures to avoid or reduce this potential interference, e.g. by adapting DL allocations accordingly, e.g. as described above.

Optionally, base station BS may comprise a determination unit DET that may be capable of determining a level of interference; determination unit DET may thus be connected to the processor and/or the Tx/Rx unit.

In the case of receiving said information, base station BS may obtain, from a neighbouring base station or from a network management node (and via this node indirectly from a neighbouring base station), information on resource allocations that may be subject to interference, e.g. UL allocations like PUCCH. This information may be evaluated by above-mentioned processor, which in turn adapts the TDD configuration resp. resource allocation for the transmit/receive unit Tx/Rx accordingly, e.g. as described above.

By the above-described measures, avoidance or adaptation of DL transmission from a potentially interfering BS can ensure that PUCCH in the neighboured cell is saved from excessive interference.

1-26. (canceled)

27. A method for allocation of radio resources in a radio base station of a communication network, the method comprising:
adapting resource allocation for radio transmission in the radio base station based on information on resource allocation in a neighboring radio base station, such that interference of signals transmitted from the radio base station with signal transmitted from, or received by, the neighboring radio base station is reduced.

28. The method of claim 27, further comprising obtaining the information on resource allocation in the neighboring station via a communication link between the radio base station and the neighboring radio base station.

29. The method of claim 27, wherein the radio base station requests the information on resource allocation in the neighboring radio base station.

30. The method of claim 27:
wherein the information on resource allocation in the neighboring radio base station comprises information on resource elements in which the neighboring radio base station has scheduled uplink resources;
wherein the adapting comprises not scheduling downlink resources in resource elements corresponding to the resource elements in which the neighboring radio base station has scheduled uplink resources.

31. The method of claim 30, wherein the resource elements comprise resource elements carrying an uplink control channel, the uplink control channel being a physical uplink control channel (PUCCH) of a mobile communication system.

32. The method of claim 27:
further comprising obtaining information on a level of interference experienced by the neighboring radio base station;
wherein the adapting comprises adapting resource allocation for radio transmission in the radio base station based on the obtained information on a level of interference experienced by the neighboring radio base station this information.

33. The method of claim 27, wherein the adapting comprises reducing a radio bandwidth and/or transmission power for downlink transmission.

34. The method of claim 27, wherein the adapting comprises shifting a frequency allocation.

35. The method of claim 27, further comprising sending a notification to a mobile station served by the radio base station about the adapting of resource allocation.

36. The method of claim 27, wherein the radio base station is a radio base station of a time division duplex (TDD) wireless communication system.

37. A method for operating a communication system, the system comprising a first radio base station and a second radio base station, the method comprising:
adapting resource allocation for radio transmission in the first radio base station based on information on resource allocation in the second radio base station, such that interference of signals transmitted from the first radio base station with signal transmitted from, or received by, the second radio base station is reduced.

38. The method of claim 37, further comprising transmitting the information on resource allocation in the second radio base station via a communication link between the second radio base station and the first radio base station.

39. The method of claim 37, further comprising the second radio base station transmitting information on resource allocation to the first radio base station.

40. The method of claim 37:
wherein the information comprises information on resource elements in which the second radio base station has scheduled uplink resources;
wherein the adapting comprises not scheduling, by the first radio base station, downlink resources in resource elements corresponding to the resource elements in which the second radio base station has scheduled uplink resources.

41. The method of claim 40, wherein:
the communication network is a mobile communication network; and
the resource elements comprise resource elements carrying an uplink control channel, the uplink control channel being a physical uplink control channel (PUCCH) of the mobile communication network.

42. The method of claim 37:
further comprising determining a level of interference experienced by the second radio base station;
further comprising transmitting information on the level of interference to the first radio base station; and
wherein the adapting is further based on the information on the level of interference.

43. The method of claim 37, wherein the adapting comprises reducing a radio bandwidth and/or transmission power for downlink transmission.

44. The method of claim 37, wherein the adapting comprises shifting a frequency allocation.

45. The method of claim 37, wherein the communication system is a time division duplex (TDD) wireless communication system.

46. A radio base station of a communication network, the radio base station comprising:
one or more processing circuits configured to cause the radio base station to:
obtain information on uplink resource allocation in a neighboring radio base station; and
adapt allocation of downlink resources based on the information.

47. The radio base station of claim 46, wherein the one or more processing circuits are configured to cause the radio base station to adapt allocation of downlink resources based on the information such that interference of signals transmitted from the radio base station with signal transmitted from, or received by, the neighboring radio base station is reduced.

48. A communication system, comprising:
a first radio base station;
a second radio base station;
wherein communication system is configured to adapt resource allocation for radio transmission in the first radio base station based on information on resource allocation in the second radio base station.

49. The communication system of claim 48, wherein the first radio base station comprises one or more processing circuits configured to cause the first radio base station to:
obtain information on uplink resource allocation in a neighboring radio base station;
adapt allocation of downlink resources based on the information.

50. The communication system of claim 49, wherein the one or more processing circuits are configured to cause the radio base station to adapt allocation of downlink resources based on the information such that interference of signals transmitted from the radio base station with signal transmitted from, or received by, the neighboring radio base station is reduced.

51. A computer program product stored in a non-transitory computer readable medium for controlling allocation of radio resources in a radio base station of a communication network, the computer program product comprising software instructions which, when run on one or more processors of the radio base station, causes the radio base station to:
adapt resource allocation for radio transmission in the radio base station based on information on resource allocation in a neighboring radio base station, such that interference of signals transmitted from the radio base station with signal transmitted from, or received by, the neighboring radio base station is reduced.

52. A computer program product stored in a non-transitory computer readable medium for operating a communication system, the system comprising a first radio base station and a second radio base station, the computer program product comprising software instructions which, when run on one or more processors of communication system, causes the communication system to:
adapt resource allocation for radio transmission in the first radio base station based on information on resource allocation in the second radio base station, such that interference of signals transmitted from the first radio base station with signal transmitted from, or received by, the second radio base station is reduced.
